(19) United States
(12) Patent Application Publication
(10) Pub. No.: US 2015/0082235 A1
(43) Pub. Date: Mar. 19, 2015

(54) DIFFERENCE-ORIENTED USER INTERFACE CREATION

(71) Applicant: Alex Volchok, Tel Aviv (IL)

(72) Inventor: Alex Volchok, Tel Aviv (IL)

(21) Appl. No.: 14/026,736

(22) Filed: Sep. 13, 2013

(51) Int. Cl. G06F 3/0481

(52) U.S. Cl. CPC G06F 3/0481
USPC 715/781

(57) ABSTRACT

The present disclosure involves systems, software, and computer implemented methods for creating user interface views. One example method includes displaying a first user interface view of an application. The first user interface view is associated with a first user interface definition. A request to display a second user interface view associated with the first user interface view is received. A set of deltas associated with the second user interface view is identified. The set of deltas defines differences between the first user interface view and the second user interface view. The second user interface view is rendered by applying the set of deltas associated with the second user interface view to the first user interface definition.

### TECHNICAL FIELD

The present disclosure relates to computer-implemented methods, software, and systems for creating user interface views.

### BACKGROUND

Enterprise portals are frameworks for integrating information, people, and processes across organizational boundaries. Portals can provide a secure unified access point, often in the form of a web-based user interface, and are designed to aggregate and personalize information through application-specific portlets, portal applications, and other components. One hallmark of enterprise portals is the decentralized content contribution and content management, which keeps the information always updated. In many cases, specific portal pages may be defined by a highly experienced administrator using a portal content administration environment or a key user within a particular organization using specific tools to define aspects, relationships, and connections for and between content provided within specific portal pages.

A web-based user interface used for a portal can include various user interface controls, such as command buttons, links, list boxes, option buttons, and other types of controls. Each user interface control may be represented by a software object. Each software object may include a set of properties defined by the type of the object. For example, each command button object may include one or more font-related properties, one or more size-related properties, and one or more color-related properties (e.g., foreground-color, background-color), among other properties. Each property of an object can have a property value. For example, a foreground-color property may have a value of ‘black’.

### SUMMARY

The present disclosure involves systems, software, and computer implemented methods for creating user interface views. One example method includes displaying a first user interface view of an application. The first user interface view is associated with a first user interface definition. A request to display a second user interface view associated with the first user interface view is received. A set of deltas associated with the second user interface view is identified. The set of deltas defines differences between the first user interface view and the second user interface view. The second user interface view is rendered by applying the set of deltas associated with the second user interface view to the first user interface definition.

While generally described as computer-implemented software embodied on tangible and/or non-transitory media that processes and transforms the respective data, some or all of the aspects may be computer-implemented methods or further included in respective systems or other devices for performing this described functionality. The details of these and other aspects and embodiments of the present disclosure are set forth in the accompanying drawings and the description below. Other features, objects, and advantages of the disclosure will be apparent from the description and drawings, and from the claims.

### DESCRIPTION OF DRAWINGS

FIG. 1 is a block diagram illustrating an example system for creating user interface views.

FIGS. 2 and 3 illustrate example user interface views.

FIG. 4A is a flowchart of an example method for displaying user interface views.

FIGS. 4B and 4C are flowcharts of example methods for re-displaying a user interface view.

FIGS. 5A and 5B are flowcharts of an example method for displaying user interface views.

FIG. 6 is a flowchart of an example method for initializing a view state.

FIG. 7 illustrates an example view states log.

### DETAILED DESCRIPTION

A user interface designer or author can define a set of user interface views for an application. The user interface designer can specify that a user interface view includes a set of renderable objects (e.g., user interface elements) that describe the user interface view. A renderable object can be, for example, a text box, a command button, a menu, a list box, an option button, or some other type of user interface element or control. The user interface designer can specify, for each renderable object, a set of properties that define a respective renderable object's appearance.

The user interface designer can define a base (e.g., initial) user interface view for the application where the definition for the base user interface view includes an object definition for each renderable object included in the base user interface view and a set of property values for each renderable object. When defining a next user interface view for the application, the user interface designer can include in the definition for the next user interface view descriptions of differences between the base user interface view and the next user interface view, rather than including a full description of each object in the next user interface view. Defining just differences, or deltas, between views can save development time for the user interface designer as compared to fully defining each user interface view. By doing so, the developer can reuse objects introduced in the base view or in a previously defined view. Additionally, storing deltas can result in smaller-sized user interface definitions as compared to storing a full definition for each user interface view, which can save memory and disk space and can result in a faster and smaller transfer of data between a client and server. Changing between user interface views by applying deltas can be faster due to less rendering as compared to rendering an entire user interface view.

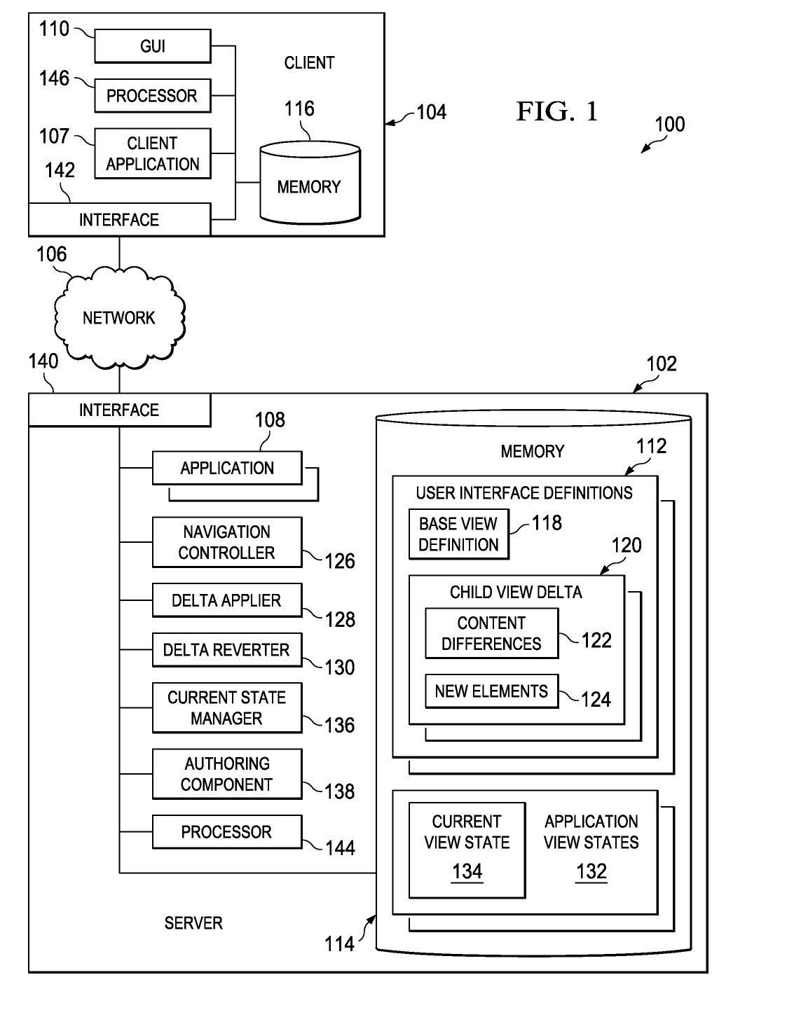

FIG. 1 is a block diagram illustrating an example system 100 for creating user interface views. Specifically, the illustrated system 100 includes or is communicably coupled with a server 102, a client device 104, and a network 106. Although shown separately, in some implementations, functionality of two or more systems or servers may be provided by a single system or server. Alternatively, elements illustrated in a single element may be split into two or more elements in some implementations.

The client device 104 may generally be any computing device operable to connect to or communicate with the server 102 via the network 106 using a wireline or wireless connection. In general, the client device 104 comprises an electronic computer device operable to receive, transmit, process, and store any appropriate data associated with the system 100 of FIG. 1. The client device 104 can include one or more client applications, including an application 107. A client application 107 is any type of application that allows the client device 104 to request and view content on the client device 104. In some implementations, a client application 107 can use parameters, metadata, and other information received at launch to access a particular set of data from the server 102. In some instances, a client application 107 may be an agent or client-side version of the one or more enterprise applications 108 running on the server 102.

A GUI (Graphical User Interface) 110 of the client device 104 interfaces with at least a portion of the system 100 for any suitable purpose, including generating a visual representation of the client application 107. In particular, the GUI 110 may be used to view and navigate various Web pages or other user interfaces. Generally, the GUI 110 provides the user with an efficient and user-friendly presentation of business data provided by or communicated within the system. The GUI 110 may comprise a plurality of customizable frames or views having interactive fields, pull-down lists, and buttons operated by the user.

The user interface views presented by the client application 107 may be defined by a user interface definition, such as a user interface definition 112 stored in memory 114 of the server 102. In some implementations, the user interface definition 112 is downloaded to and stored in the client device 104, such as in memory 116 of the client device 104. The user interface definition 112 includes a base view definition 118 and one or more child view deltas 120. In other instances, the user interface definition 112 and child view deltas 120 may be accessed remotely by the client application 107, such as at the server 102.

The base view definition 118 defines an initial user interface view of the client application 107. The base view definition 118 can include a definition of one or more renderable objects describing the initial user interface view. Each renderable object can be associated with a set of properties defining the particular renderable object's appearance.

The child view deltas 120 can define differences between a child user interface view and the parent of the child user interface view. For example, a second user interface view may be defined by defining differences between the second user interface view and the initial user interface view. A third user interface view can be defined by defining differences between the third user interface view and the second user interface view. The user interface definition 112 can include a set of child view deltas 120 for each view in the client application 107 other than the initial view.

The child view deltas 120 include content differences 122 and new elements 124. The content differences 122 can include items which describe content differences between a view and the parent of the view. Each item in the content differences 122 can include (1) an element identifier of a user interface element which has differences between the view and the parent view and (2) a set of properties which describe the differences. The new elements 124 describe one or more new elements to include in a view, and specifically, elements that appear in the child view but that do not appear in the parent of the view. For each new element, an element identifier which identifies the new element and a set of properties which describes the appearance of the new element can be stored.

The client device 104 can send a request to execute the client application 107 to the server 102. The server 102 can send the user interface definition 112 to the client device 104 and an initial user interface view associated with the base user interface definition 118 can be rendered on the GUI 110. In alternative implementations, the initial user interface view may be associated with a non-base view (i.e., a child or grandchild user interface view from the base user interface view.

A navigation controller 126 at server 102 can manage transitions between user interface views of the client application 107. For example, the navigation controller 126 can receive a request to transition the client application 107 from the initial user interface view to a first child user interface view. In response to a request to transition the client application 107 to the first child user interface view, the navigation controller 126 can send a request to a delta applier 128. The delta applier 128 can identify a child view delta 120 associated with the first child user interface view (as compared to the initial user interface view) and can apply the content differences 122 and can create new elements that are defined in the new elements 124. The applied content differences 122 and the created new elements 124 can be rendered onto the GUI 110.

The navigation controller 126 can receive other requests to transition to other views, for example, to transition from the first child user interface view to a second child user interface view. As another example, the navigation controller 126 can receive a request to transition from the first child user interface view to the initial user interface view. In response to a request to transition to a view that is an ancestor (e.g., parent) of the currently-displayed view, the navigation controller 126 can send a request to a delta reverter 130 to revert deltas that had been applied in the showing of one or more views since the presentation of the ancestor view. The delta reverter 130 can identify one or more sets of child deltas 120 that had been applied since the presentation of the ancestor view and can revert each of the identified deltas. In some instances, the delta applier 128 and the delta reverter 130 may be a single element or component. Additionally, both elements may be a part of another component, such as the navigation controller 126.

As described in more detail below, in some implementations, user interface views can be dynamic and can change at runtime. An application view states log 132 can be maintained for the client application 107 and can include a current view state entry 134 for each presented view. When transitioning away from a view, or prior to receiving a transition request, a current state manager 136 can store the current state of the view in the current view state entry 134 associated with the view. If a request to re-display the view is received, the current state manager 136 can identify the saved state from the view state entry 134 and can use the saved state to re-display the view.

Although described as residing in the server 102, some or all of the navigation controller 126, the delta applier 128, the delta reverter 130, and the current state manager 136 can be downloaded to and executed on the client device 104. The application view states log 132 can also be downloaded to the client device 104 and stored in the memory 116. Similarly, one or more of these components may reside and be executed on one or more alternative computing devices.

Although one client device 104 is displayed, other client devices may be included in the system 100. For example, the system 100 can include an authoring client device. A user with appropriate rights and permissions can use the authoring client device to interface with an authoring component 138 to define the base user interface definition 118 and the child view deltas 120.

As used in the present disclosure, the term “computer” is intended to encompass any suitable processing device. For example, although FIG. 1 illustrates a single server 102 and a single client 104, the system 100 can be implemented using a single, stand-alone computing device, two or more servers 102, or two or more clients 104. Indeed, the server 102 and the client device 104 may be any computer or processing device such as, for example, a blade server, general-purpose personal computer (PC), Mac®, workstation, UNIX-based workstation, or any other suitable device. In other words, the present disclosure contemplates computers other than general purpose computers, as well as computers without conventional operating systems. Further, the server 102 and the client device 104 may be adapted to execute any operating system, including Linux, UNIX, Windows, Mac OS®, Java™, Android™, iOS or any other suitable operating system. According to one implementation, the server 102 may also include or be communicably coupled with an e-mail server, a Web server, a caching server, a streaming data server, and/or other suitable server.

Interfaces 140 and 142 are used by the server 102 and the client device 104, respectively, for communicating with other systems in a distributed environment—including within the system 100—connected to the network 106. Generally, the interfaces 140 and 142 each comprise logic encoded in software and/or hardware in a suitable combination and operable to communicate with the network 106. More specifically, the interfaces 140 and 142 may each comprise software supporting one or more communication protocols associated with communications such that the network 106 or interface's hardware is operable to communicate physical signals within and outside of the illustrated system 100.

The server 102 includes one or more processors 144. Each processor 144 may be a central processing unit (CPU), a blade, an application specific integrated circuit (ASIC), a field-programmable gate array (FPGA), or another suitable component. Generally, each processor 144 executes instructions and manipulates data to perform the operations of the server 102. Specifically, each processor 144 executes the functionality required to receive and respond to requests from the client device 104, for example.

Regardless of the particular implementation, “software” may include computer-readable instructions, firmware, wired and/or programmed hardware, or any combination thereof on a tangible medium (transitory or non-transitory, as appropriate) operable when executed to perform at least the processes and operations described herein. Indeed, each software component may be fully or partially written or described in any appropriate computer language including C, C++, Java™, JavaScript®, Visual Basic, assembler, Perl®, any suitable version of 4GL, as well as others. While portions of the software illustrated in FIG. 1 are shown as individual modules that implement the various features and functionality through various objects, methods, or other processes, the software may instead include a number of sub-modules, third-party services, components, libraries, and such, as appropriate. Conversely, the features and functionality of various components can be combined into single components as appropriate.

The memory 114 may include any type of memory or database module and may take the form of volatile and/or non-volatile memory including, without limitation, magnetic media, optical media, random access memory (RAM), read-only memory (ROM), removable media, or any other suitable local or remote memory component. The memory 114 may store various objects or data, including caches, classes, frameworks, applications, backup data, business objects, jobs, web pages, web page templates, database tables, repositories storing business and/or dynamic information, and any other appropriate information including any parameters, variables, algorithms, instructions, rules, constraints, or references thereto associated with the purposes of the server 102. In some implementations, the server 102 includes multiple memories.

The client device 104 includes one or more processors 146. Each processor 146 included in the client device 104 may be a central processing unit (CPU), an application specific integrated circuit (ASIC), a field-programmable gate array (FPGA), or another suitable component. Generally, each processor 146 included in the client device 104 executes instructions and manipulates data to perform the operations of the client device 104. Specifically, each processor 146 included in the client device 104 executes the functionality required to send requests to the server 102 and to receive and process responses from the server 102.

The client device 104 is generally intended to encompass any client computing device such as a laptop/notebook computer, wireless data port, smart phone, personal data assistant (PDA), tablet computing device, one or more processors within these devices, or any other suitable processing device. For example, the client device 104 may comprise a computer that includes an input device, such as a keypad, touch screen, or other device that can accept user information, and an output device that conveys information associated with the operation of the server 102, or the client device 104 itself, including digital data, visual information, or the graphical user interface 110.

The memory 116 included in the client device 104 may include any memory or database module and may take the form of volatile or non-volatile memory including, without limitation, magnetic media, optical media, random access memory (RAM), read-only memory (ROM), removable media, or any other suitable local or remote memory component. The memory 116 may store various objects or data, including user selections, caches, classes, frameworks, applications, backup data, business objects, jobs, web pages, web page templates, database tables, repositories storing business and/or dynamic information, and any other appropriate information including any parameters, variables, algorithms, instructions, rules, constraints, or references thereto associated with the purposes of the client device 104.

There may be any number of client devices 104 associated with, or external to, the system 100. For example, while the illustrated system 100 includes one client device 104, alternative implementations of the system 100 may include multiple client devices 104 communicably coupled to the server 102 and/or the network 106, or any other number suitable to the purposes of the system 100. Additionally, there may also be one or more additional client devices 104 external to the illustrated portion of system 100 that are capable of interacting with the system 100 via the network 106. Further, the term “client”, “client device” and “user” may be used interchangeably as appropriate without departing from the scope of this disclosure. Moreover, while the client device 104 is described in terms of being used by a single user, this disclosure contemplates that many users may use one computer, or that one user may use multiple computers.

In some implementations, the system 100 supports, for example, a client-side enrichment scenario, in which definitions of user interface views that are generated during run time on the client device 104 are provided to the server 102 and subsequently reused. As another example, in some implementations, the system 100 supports a server content push scenario, in which the server 102 creates runtime changes to user interface views that are currently running on the client device 104 and provides the changes to the client device 104. The server content push scenario can be used, for example, in a Comet web application model in which the server 102 updates user interface views presented on the client device 104.

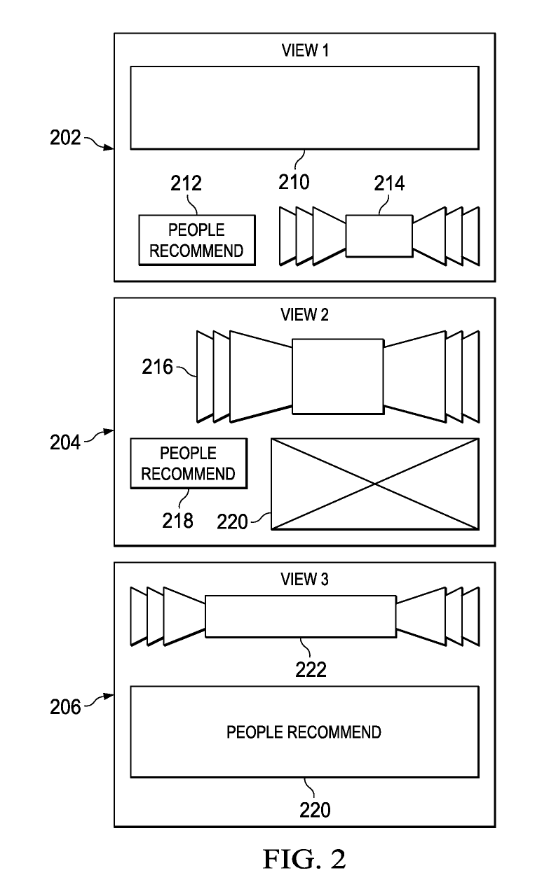

FIG. 2 illustrates example user interface views 202, 204, and 206. The user interface view 202 can be, for example, a base user interface view (e.g., a view that is first displayed when an application which includes the user interface view 202 is started). As another example, the user interface view 202 can be a child or other descendant of another base view. The user interface view 202 includes a content area 210, a recommended list 212, and thumbnails 214. The thumbnails 214 can be thumbnails of images, videos, or some other type of content.

The user interface view 204 can be displayed, for example, in response to the user selecting a thumbnail in the thumbnails 214. The user interface view 204 includes enlarged thumbnails 216, a recommended list 218, and a communications area 220. The user interface 204 can be defined using a set of deltas which define differences between the user interface view 202 and the user interface view 204.

For example, the deltas associated with the user interface view 204 can include descriptions of new objects to include in the user interface 204 and changes to objects that are included in the user interface 202. For example, the deltas associated with the user interface view 204 can include descriptions of changes to property values of properties of the thumbnails 214 which can result in the displaying of the enlarged thumbnails 216 in a new location and in a larger size as compared to the thumbnails 214. As another example, the deltas associated with the user interface view 204 can include the definition of the new object represented by the communications area 220, including a set of property values which define the appearance of the communications area 220.

The deltas associated with the user interface view 204 can include information which indicates that the user interface view 204 does not include the content area 210. That is, the deltas associated with the user interface view 204 can indicate that the content area 210 is to be hidden when the user interface 204 is displayed. In some implementations, the deltas associated with the user interface view 204 do not include information associated with either the recommended list 212 or the recommended list 218, which can indicate that the recommended list 218 is to appear in the user interface view 204 with a same appearance as the recommended list 212.

As mentioned, a request to display the user interface 204 can be received, for example, in response to selection of a thumbnail in the thumbnails 214. In response to a request to display the user interface 204, the set of deltas associated with the user interface view 204 can be identified. The user interface view 204 can be rendered by applying the set of deltas associated with the user interface view 204. For example, the content area 210 can be hidden, the communications area can be rendered, and the appearance and location of the thumbnails 214 can be changed to cause display of the enlarged thumbnails 216.

A request to display the user interface view 206 can be received, for example, in response to user selection of the recommended list 212, as well as any other suitable indication, request, or selection. In response to receiving the request to display the user interface view 206, a set of deltas associated with the user interface view 206 can be identified, where the set of deltas associated with the user interface view 206 defines differences between the user interface view 204 and the user interface view 206. The user interface view 206 can be rendered by applying the set of deltas associated with the user interface view 206. For example, an enlarged recommended list 220 can be displayed by applying property changes to the recommended list 218, the communications area 220 can be hidden, and the appearance of the enlarged thumbnails 216 can be changed to cause display of thumbnails 222.

The user interface view 204 can be considered a child of the user interface view 202, as its set of deltas act directly upon the properties and elements of user interview view 202. Similarly, the user interface view 206 can be considered a child of the user interface view 204. To transition from a child user interface view to a parent user interface view, the deltas associated with the child user interface view can be reverted. For example, to re-display the user interface view 202 after displaying the user interface view 204, the deltas associated with the user interface view 204 can be reverted, including the hiding of the shown communications area 220, the showing of the hidden content area 210, and the setting of properties of the enlarged thumbnails 216 to move and resize the enlarged thumbnails 216 so the enlarged thumbnails 216 appear as the thumbnails 214.

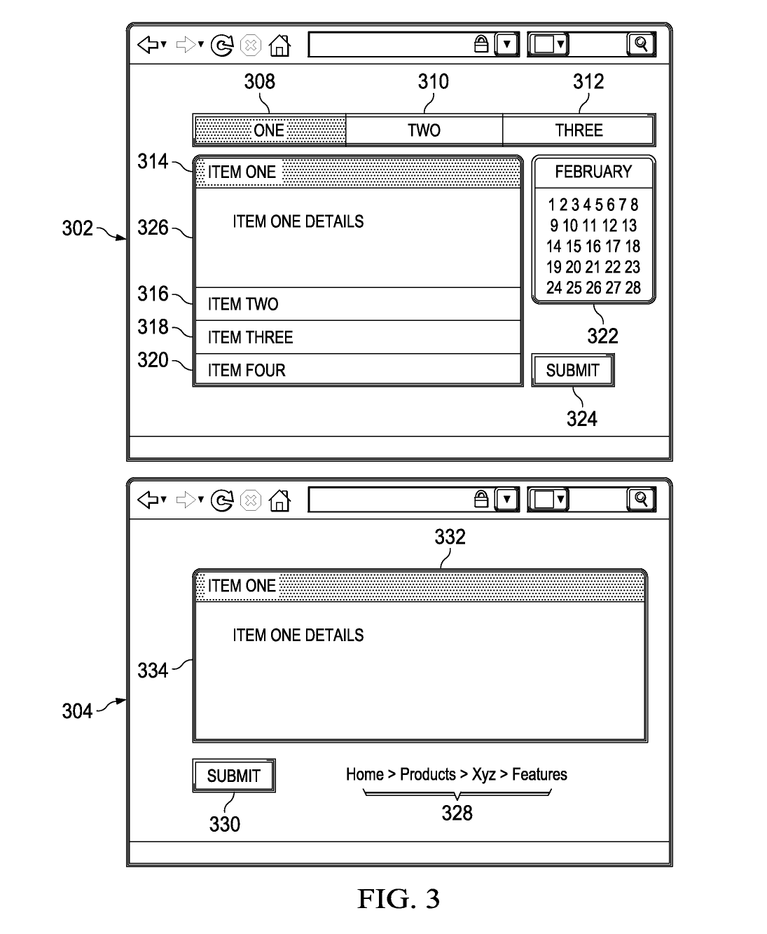

FIG. 3 illustrates example user interface views 302 and 304. The user interface view 302 can be a base user interface view and includes controls 308, 310, and 312, item one 314, item two 316, item three 318, item four 320, a calendar 322, and a submit control 324. Item one 314 includes item one details 326.

The user interface view 304 can be defined as a set of deltas which define differences between the user interface view 304 and the user interface view 302. For example, the deltas associated with the user interface view 304 can include information which indicates the removal of the control 308, the control 310, the control 312, the item two 316, the item three 318, the item four 320, and the calendar 322. The deltas associated with the user interface view 304 can also include information which describes new link controls 328 and property changes to cause the submit control 324 to appear as a submit control 330, item one 314 to appear as an item one 332, and item one details 326 to appear as item one details 334.

A request to display the user interface view 304 can be received, for example, in response to user selection of item one 314. In response to receiving the request to display the user interface view 304, the set of deltas associated with the user interface view 304 can be identified and can be applied. To re-display the user interface view 302, the set of deltas associated with the user interface view 304 can be reverted.

In some implementations, when the request to display the user interface view 304 is received, the current state of the user interface 302 is saved. That is, the current state of the user interface view 302 may be different than an initial state of the user interface view 302, such as due to dynamic user interface changes. When a request to re-display the user interface 302 is received, the saved state can be restored.

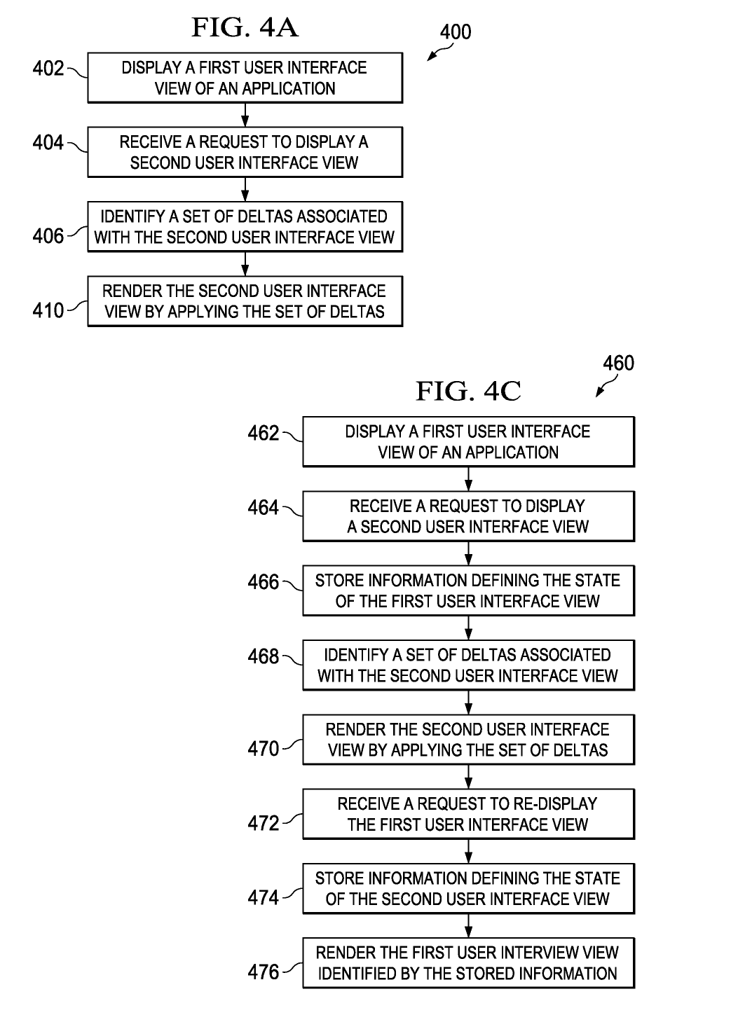

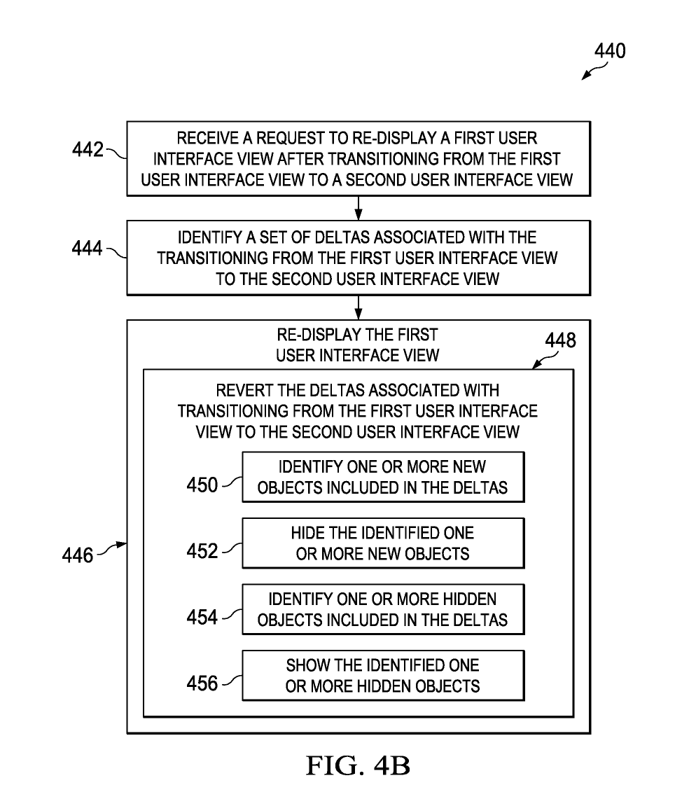

FIG. 4A is a flowchart of an example method 400 for creating user interface views. It will be understood that method 400 and related methods may be performed, for example, by any suitable system, environment, software, and hardware, or a combination of systems, environments, software, and hardware, as appropriate. For example, one or more of a client, a server, or other computing device can be used to execute method 400 and related methods and obtain any data from the memory of a client, the server, or the other computing device. In some implementations, the method 400 and related methods are executed by the system 100 described above with respect to FIG. 1.

At 402, a first user interface view of an application is displayed, the first user interface view associated with a first user interface definition. The first user interface definition can include a definition of one or more renderable objects describing the first user interface view. Each renderable object can be associated with a set of properties defining the particular renderable object's appearance.

At 404, a request to display a second user interface view associated with the first user interface view is received. For example, the first user interface view can be a base view of the application and the second user interface view can be a child view of the base view. Alternatively, the first user interface view may be child view of another base view, with the second user interface view being a child view of the first user interface view, and therefore a grandchild of the base view. In some instances, the second user interface view and a third user interface view are both direct descendants of the first user interface view and a request to display either of the second or third user interface views can be received. In some instances, the second user interface view may be, for example, a grandchild of the first user interface view.

At 406, a set of deltas associated with the second user interface view is identified, the set of deltas defining differences between the first user interface view and the second user interface view. The set of deltas can be identified, for example, in a second user interface definition that is associated with the second user interface view. The second user interface definition can be derived from the first user interface definition and can include at least one modification from the first user interface definition. A modification from the first user interface definition can represent a delta between the first user interface definition and the second user interface definition. For example, a delta associated with the second user interface view can define a modification to a property associated with a renderable object defined in the first user interface definition. The set of deltas associated with the second user interface view can include one or more new objects to include in the second user interface view. The new objects can be objects not included in the first user interface definition. The set of deltas can indicate one or more objects to hide, or not include, in the second user interface view that are included in the first user interface view.

At 408, the second user interface view is rendered by applying the set of deltas associated with the second user interface view to the first user interface definition. For example, new objects can be shown and rendered according to properties describing the new objects. Objects for which the set of deltas include modifications can be re-rendered in accordance with the modifications. One or more objects included in the first user interface view but not to be included in the second user interface view can be hidden. In instances where, for example, the second user interface view is a grandchild or a more removed descendant of the first user interface view, transitioning from the first user interface view to the second user interface view may include applying the deltas associated with the second user interface view and all intervening user interface views.

FIG. 4B is a flowchart of an example method 440 for re-displaying a user interface view. It will be understood that method 440 and related methods may be performed, for example, by any suitable system, environment, software, and hardware, or a combination of systems, environments, software, and hardware, as appropriate. For example, one or more of a client, a server, or other computing device can be used to execute method 440 and related methods and obtain any data from the memory of a client, the server, or the other computing device. In some implementations, the method 440 and related methods are executed by the system 100 described above with respect to FIG. 1.

At 442, a request to re-display a first user interface view is received after transitioning from the first user interface view to a second user interface view. For example, a “back” command may be received while the second user interface view is displayed, a request to close the second user interface view may be received, or some other user input indicating a request to re-display the first user interface view can be received.

At 444, a set of deltas associated with the transitioning from the first user interface view to the second user interface view is identified. The set of deltas can be identified, for example, in a user interface definition associated with the second user interface view.

At 446, the first user interface view is re-displayed. The re-displaying of the first user interface view can include, at 448, the reverting of the identified deltas associated with the transitioning from the first user interface view to the second user interface view.

The reverting of the deltas associated with the second user interface view can include reverting modifications identified in the deltas. For example, when transitioning from the first user interface view to the second user interface view, one or more properties of one or more objects may have each been changed from a first property value associated with the first user interface view to a second property value associated with the second user interface view. The reverting of the deltas associated with the second user interface view can include restoring of the one or more properties of the one or more objects to respective first property values from respective second property values.

The reverting of the deltas associated with the second user interface view can include, at 450, the identification of one or more new objects included in the deltas. For example, each object in a user interface definition can be identified by an object identifier (e.g., a reference identifier). The identification of one or more new objects included in the deltas can include identifying objects in the deltas that are not included in a user interface definition associated with the first user interface view.

At 452, the identified one or more new objects are hidden. That is, new objects that had been shown as a result of transitioning from the first user interface view to the second user interface view can be hidden when re-displaying the first user interface view.

The reverting of the deltas associated with the second user interface view can include, at 454, the identification of one or more hidden objects included in the deltas. At 456, the identified one or more hidden objects are shown. That is, objects that had been hidden as a result of transitioning from the first user interface view to the second user interface view can be shown when re-displaying the first user interface view.

FIG. 4C is a flowchart of an example method 460 for re-displaying a user interface view. It will be understood that method 460 and related methods may be performed, for example, by any suitable system, environment, software, and hardware, or a combination of systems, environments, software, and hardware, as appropriate. For example, one or more of a client, a server, or other computing device can be used to execute method 460 and related methods and obtain any data from the memory of a client, the server, or the other computing device. In some implementations, the method 460 and related methods are executed by the system 100 described above with respect to FIG. 1.

At 462, a first user interface view of an application is displayed. The first user interface view can be associated with a first user interface definition. The first user interface definition can include a definition of one or more renderable objects describing the first user interface view. Each renderable object can be associated with a set of properties defining the particular renderable object's appearance.

At 464, a request to display a second user interface view associated with the first user interface view is received. For example, the first user interface view can be a base view of the application and the second user interface view can be a child view of the base view.

At 466, information defining the state of the first user interface view is stored in response to the request. For example, property values of each visible object in the first user interface view can be stored in an entry associated with the first user interface view in a view states log. Some stored property values can differ, for example, for one or more properties, from values the properties had when the first user interface view was initially displayed, for example, due to dynamic user interface changes occurring in the first user interface view. In some instances, the state of the first user interface view may be stored upon presentation without requiring the request to be received.

At 468, a set of deltas associated with the second user interface view is identified. The set of deltas can define differences between the first user interface view and the second user interface view. The set of deltas can be identified, for example, in a second user interface definition that is associated with the second user interface view. One example set of deltas may include the following code:

```
  {parentViewId:22,changesToCurrentElements:[
elementId,propetyChanges:[
color:“red” // where parent was “black”
background:“green” // where parent was “blue”
// additional modification may be included
  ],newElements:[{newButton,properties:[ ] }]}
  ]
})
```

At 470, the second user interface view is rendered by applying the set of deltas associated with the second user interface view to the first user interface definition. For example, new objects can be shown and rendered according to properties describing the new objects. Objects for which the set of deltas include modifications can be re-rendered in accordance with the modifications. One or more objects included in the first user interface view but not to be included in the second user interface view can be hidden.

At 472, a request to re-display the first user interface view is received. For example, a “back” command may be received while the second user interface view is displayed, a request to close the second user interface view may be received, or some other user input indicating a request to re-display the first user interface view can be received.

At 474, information defining the state of the second user interface view is stored. For example, property values of each visible object in the second user interface view can be stored in an entry associated with the second user interface view in the view states log. Some stored property values can differ, for example, for one or more properties, from values the properties had when the second user interface view was initially displayed, for example, due to dynamic user interface changes occurring in the second user interface view. The stored information defining the state of the second user interface can be used, for example, when the second user interface view is re-displayed.

At 476, the first user interview view identified by the stored information defining the state of the first user interface view is rendered in response to the request to re-display the first user interface view. For example, currently displayed objects can be hidden and stored objects for which stored information exists can be rendered according to property values stored for the stored objects.

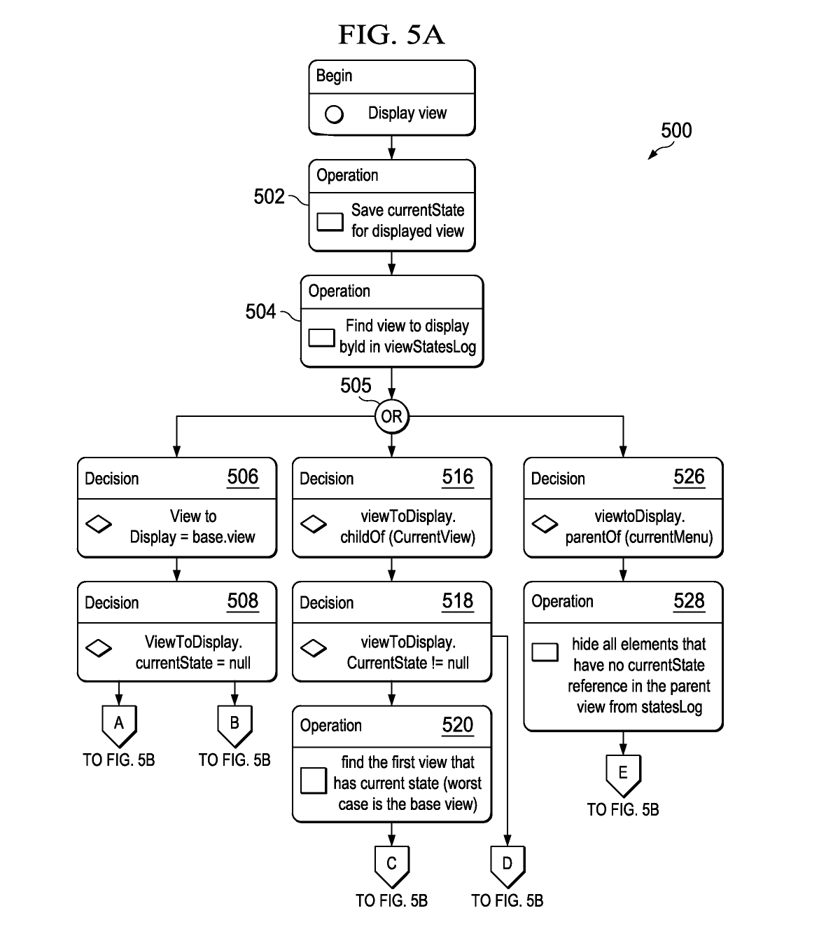

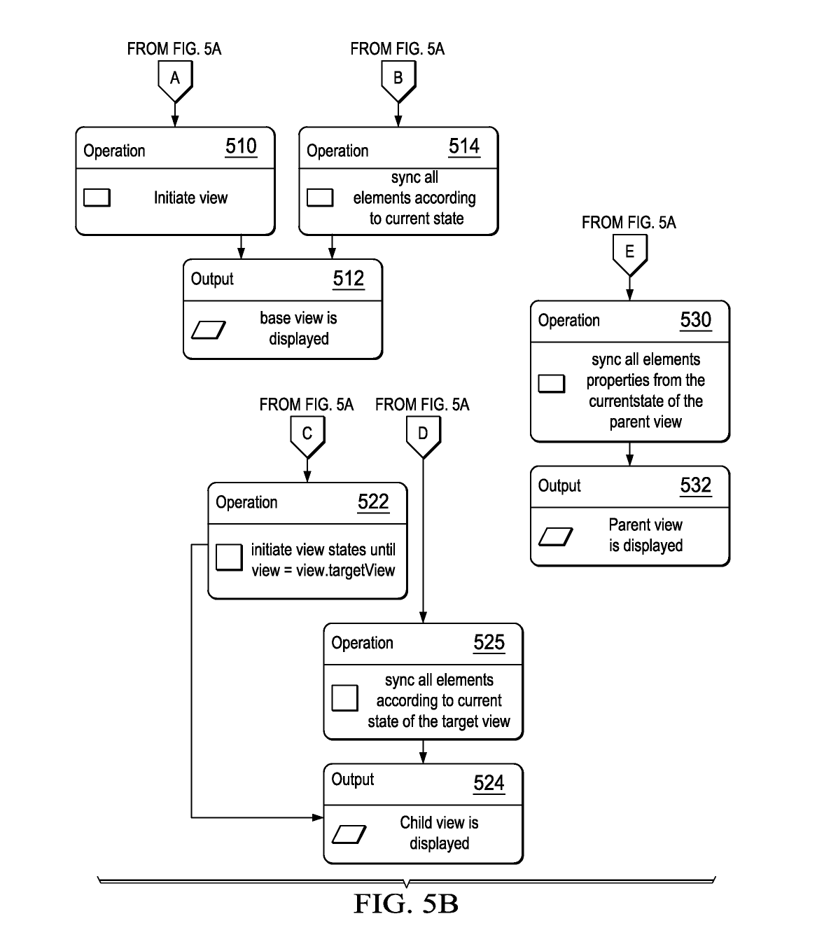

FIGS. 5A and 5B are flowcharts of an example method 500 for displaying user interface views. It will be understood that method 500 and related methods may be performed, for example, by any suitable system, environment, software, and hardware, or a combination of systems, environments, software, and hardware, as appropriate. For example, one or more of a client, a server, or other computing device can be used to execute method 500 and related methods and obtain any data from the memory of a client, the server, or the other computing device. In some implementations, the method 500 and related methods are executed by the system 100 described above with respect to FIG. 1.

At 502, a current state of the displayed view is saved. For example, for each of a set of objects, current properties values for a set of properties describing the object can be saved.

At 504, an entry corresponding to the view to display is found in the view states log, such as by finding an entry that includes a view identifier associated with the view to display. At 505, a determination is made as to whether the view to display is the base view, is a descendant (e.g., child, grandchild) of the current view, or is an ancestor (e.g., parent, grandparent) of the current view.

At 506, it is determined that the view to display is the base view. At 508, a determination is made as to whether saved current state associated with the base view is equal to a null value. That is, a determination is made as to whether current state has previously been saved for base view. For example, upon first displaying the application, current state may not yet have been saved for the base view.

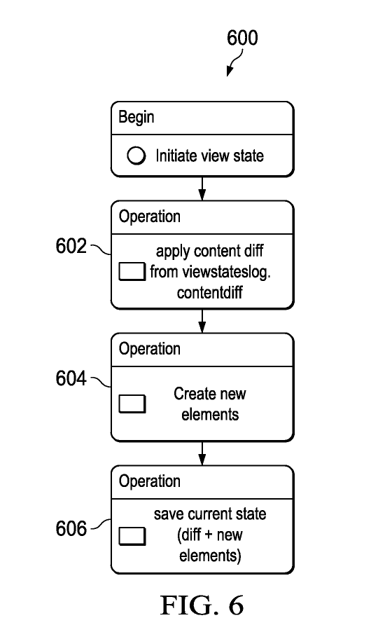

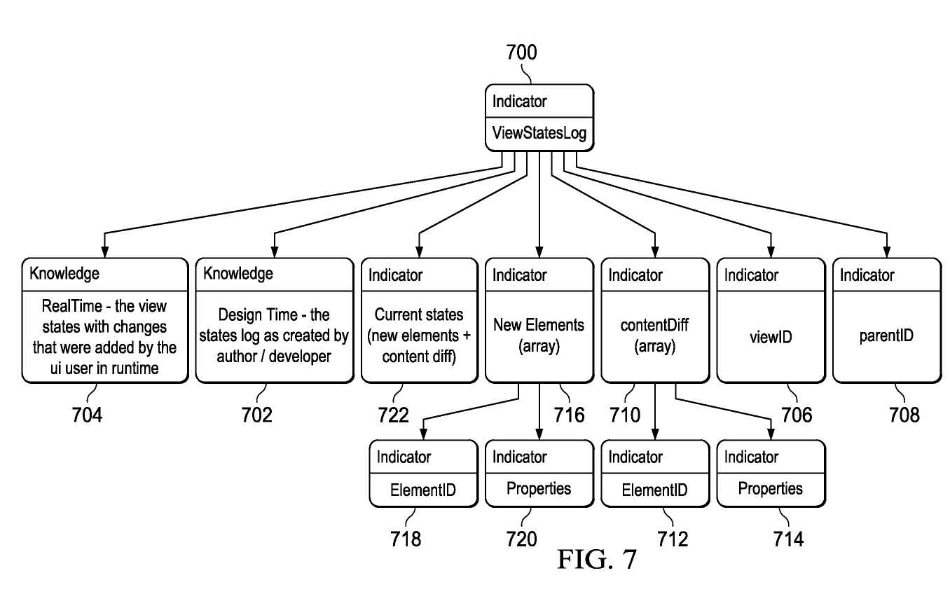

When the saved current state associated with the base view is null, the base view is initialized, at 510. For example, the base view can be initialized by an initialize view state process 600, as illustrated in FIG. 6. The initialize view state process can be called for any view, including the base view. As described above, a view can be defined as a set of delta changes from a parent view, including changes to existing objects and introduction of new objects. Since the base view has no parent, the base view can be defined as a set of new objects only (e.g., with no definition of changes to existing objects.

At 602, no processing may be performed, since the base view has no changes defined (e.g., no content differences defined). At 604, new elements are created. For example, an element (e.g., user interface element, user interface object) can be created for each visible element included in the base view.

At 606, a current state is saved for the base view. For example, the created new elements can be saved as the current state, such as by saving a set of property values for each new object.

Returning to FIG. 5, at 512, the base view is displayed (e.g., the created user interface objects can be rendered onto the display).

Referring again to step 508, when the saved current state associated with the base view is not null (e.g., current state has been previously saved for the base view), at 514, elements associated with the base view are synchronized according to the saved current state. For example, the user interface elements included in the saved current state associated with the base view can be shown and can be rendered according to associated property values included in the saved current state associated with the base view.

At 516, it is determined that the view to display is a child of the current view. At 518, a determination is made as to whether saved current state associated with the view to display is equal to a null value.

When the saved current state is equal to a null value, an entry associated with the first view that has saved current state is located in the view states log at 520. “First” can refer, for example, relative to an order in a hierarchy where the base view is ordered first, a child of the base view is ordered second, and a grandchild of the base view is ordered third, etc. If a view other than the base view has had current state saved, an entry corresponding to that view may be located. In some implementations, a base view (or any other view) may have two or more different direct children views. If no view other than the base view has had current state saved, an entry corresponding to the base view may be located.

At 522, view states for descendants of the view corresponding to the entry located in step 520 are initialized until the target view is reached. That is, an iterative process can be performed until the target view is reached. In some situations, the target view may be, for example, a direct child of the view corresponding to the entry located in step 520, and in such situations only the state of the target view is initialized. As another example, if the target view is located more than one generation beneath the view corresponding to the entry located in step 520, the iterative process can begin by identifying a view that is both a child of the view corresponding to the entry located in step 520 and an ancestor of the target view. Each view starting from the identified view and continuing through the descendant chain up to and including the target view can have an associated view state initialized. View states can be initialized, for example, using the process 600.

For example, at 602, content differences for a view to initialize can be applied. For example, one or more changes can be made to one or more object properties corresponding to one or more user interface elements.

At 604, new elements are created for the view to initialize. At 606, the current state of the initialized view is saved. For example, the new objects and the changed objects can be saved as the current state.

Referring again to FIG. 5, at 524, the child view is displayed to the user.

Referring again to step 518, when the saved current state for the view to display is not equal to a null value (e.g., current state has been previously saved for the view to display), element are synchronized according to the saved current state. The view to display is displayed, at 524.

At 526, a determination is made that the view to display is an ancestor view (e.g., parent, grandparent) of the current view. At 528, elements that are not included in saved current state associated with the ancestor view (e.g., parent) of the current view are hidden. For example, one or more user interface elements not included in the view to display may have been rendered to the screen as part of rendering the current view and such user interface elements can be hidden.

At 530, element properties are synchronized to be in accordance with the saved state of the view to display. For example, if an element property was changed from a value associated with the ancestor view as part of rendering the current view (e.g., descendant view), the property value can be changed to a value specified in the current state of the ancestor view. At 532, the view to display (e.g., ancestor (e.g., parent) view) is displayed.

FIG. 7 illustrates an example and abstract version of a view states log 700. A note 702 indicates that the view states log 700 can be created and initially populated by a user interface designer/author at design time when the user interface designer is defining user interface views for an application. That is, the view states log 700 can include predefined, static information. A note 704 indicates that the view states log 700 can include dynamic information that reflects changes in user interface views that may occur during runtime.

The view states log 700 can include an entry for each user interface view included in an application. An entry can be identified, for example, using a view identifier field 706. Other than a base user interface view, each user interface view can have a parent user interface view. An entry in the view states log 700 for a child user interface view can be linked to an entry for an associated parent user interface view using a parent identifier field 708.

An entry in the view states log 700 can include a content differences array 710, which includes an array of items which describe content differences between the view associated with the entry and the parent of the view associated with the entry. Each item in the content differences array 710 can include an element identifier 712 of a user interface element which has differences between the view and the parent view and a set of properties 714 which describe the differences.

An entry in the view states log 700 for a view can include a new elements array 716, which includes an array of items which describe new elements to include in the view. The new elements can be elements that appear in the view but that do not appear in the parent of the view. Each item in the new elements array 716 can include an element identifier 718 which identifies the new element and a set of properties 720 which describe the appearance of the new element.

The view states log 700 can include a current state 722 for each view entry. The current state 722 can include a description of the current state of the view. The current state can be stored, for example, to support dynamically changing views. When re-displaying a view, for example, the view can be restored to a previously stored current state. In some implementations, the current state 722 includes a definition of all objects in the view, including a set of properties describing the appearance of each object. In some implementations, the current state 722 describes a set of delta changes or content differences and a set of new objects, such as compared to a parent view.

The preceding figures and accompanying description illustrate example processes and computer-implementable techniques. But system 100 (or its software or other components) contemplates using, implementing, or executing any suitable technique for performing these and other tasks. It will be understood that these processes are for illustration purposes only and that the described or similar techniques may be performed at any appropriate time, including concurrently, individually, or in combination. In addition, many of the operations in these processes may take place simultaneously, concurrently, and/or in different orders than as shown. Moreover, system 100 may use processes with additional operations, fewer operations, and/or different operations, so long as the methods remain appropriate.

In other words, although this disclosure has been described in terms of certain embodiments and generally associated methods, alterations and permutations of these embodiments and methods will be apparent to those skilled in the art. Accordingly, the above description of example embodiments does not define or constrain this disclosure. Other changes, substitutions, and alterations are also possible without departing from the spirit and scope of this disclosure.

What is claimed is:

1. A method, comprising:
displaying a first user interface view of an application, the first user interface view associated with a first user interface definition;
receiving a request to display a second user interface view associated with the first user interface view;
identifying a set of deltas associated with the second user interface view, the set of deltas defining differences between the first user interface view and the second user interface view; and
rendering the second user interface view by applying the set of deltas associated with the second user interface view to the first user interface definition.

2. The method of claim 1, wherein the first user interface view is a base view of the application, and wherein the second user interface view is a child view of the base view.

3. The method of claim 1, wherein the second user interface definition is derived from the first user definition and includes at least one modification from the first user interface definition, the at least one modification representing a delta between the first user interface definition and the second user interface definition.

4. The method of claim 1, wherein the first user interface definition comprises a definition of one or more renderable objects describing the first user interface view, each renderable object associated with a set of properties defining the particular renderable object's appearance.

5. The method of claim 4, wherein the set of deltas associated with the second user interface view defines modifications to at least a portion of the set of properties associated with at least one shared renderable object defined in the first user interface definition.

6. The method of claim 4, wherein the set of deltas associated with the second user interface view includes one or more new objects to include in the second user interface view, the new objects representing objects not included in the first user interface definition.

7. The method of claim 1, further comprising:
receiving a request to re-display the first user interface view; and
re-displaying the first user interface view.

8. The method of claim 7, wherein re-displaying the first user interface view includes:
identifying the set of deltas associated with transitioning from the first user interface view to the second user interface view; and
reverting the deltas associated with transitioning from the first user interface view to the second user interface view when re-displaying the first user interface view.

9. The method of claim 7, further comprising storing information defining the state of the first user interface view prior to displaying the second user interface view in response to the request.

10. The method of claim 9, further comprising: rendering the first user interview view identified by the stored information defining the state of the first user interface view in response to the request to re-display the first user interface view.

11. The method of claim 9, wherein storing information defining the state of the first user interface view includes:
identifying one or more elements included in the first user interface view;
identifying a set of properties associated with each of the one or more identified elements; and
storing the identified one or more elements and the set of properties associated with each of the one or more identified elements in a state log.

12. The method of claim 8, wherein re-displaying the first user interface view includes identifying one or more new objects included in the deltas associated with the second user interface view and hiding the identified one or more new objects.

13. The method of claim 4, further comprising receiving a request to display a third user interface view from the second user interface view, identifying a set of deltas associated with the third user interface view, and rendering the third user interface view by applying the set of deltas associated with the third user interface view.

14. The method of claim 13, further comprising storing information defining the state of the second user interface view prior to displaying the third user interface view in response to the request.

15. The method of claim 14, further comprising:
receiving a request to re-display the second user interface view; and
rendering the second user interview view identified by the stored information defining the state of the second user interface view in response to the request to re-display the second user interface view.

16. A system comprising:
one or more computers associated with an enterprise portal; and
a computer-readable medium coupled to the one or more computers having instructions stored thereon which, when executed by the one or more computers, cause the one or more computers to perform operations comprising:
displaying a first user interface view of an application, the first user interface view associated with a first user interface definition;
receiving a request to display a second user interface view associated with the first user interface view;
identifying a set of deltas associated with the second user interface view, the set of deltas defining differences between the first user interface view and the second user interface view; and
rendering the second user interface view by applying the set of deltas associated with the second user interface view to the first user interface definition.

17. The system of claim 16, wherein the first user interface view is a base view of the application, and wherein the second user interface view is a child view of the base view.

18. The system of claim 16, wherein the second user interface definition is derived from the first user definition and includes at least one modification from the first user interface definition, the at least one modification representing a delta between the first user interface definition and the second user interface definition.

19. A computer program product encoded on a non-transitory storage medium, the product comprising non-transitory, computer readable instructions for causing one or more processors to perform operations comprising:
displaying a first user interface view of an application, the first user interface view associated with a first user interface definition;
receiving a request to display a second user interface view associated with the first user interface view;
identifying a set of deltas associated with the second user interface view, the set of deltas defining differences between the first user interface view and the second user interface view; and
rendering the second user interface view by applying the set of deltas associated with the second user interface view to the first user interface definition.

20. The product of claim 19, wherein the second user interface definition is derived from the first user definition and includes at least one modification from the first user interface definition, the at least one modification representing a delta between the first user interface definition and the second user interface definition.
